(19) United States
(12) Patent Application Publication
(10) Pub. No.: US 2016/0166361 A1
(43) Pub. Date: Jun. 16, 2016

(54) Metal Bite Strip

(71) Applicant: Byung Kee CHOI, Seoul (KR)

(72) Inventor: Byung Kee CHOI, Seoul (KR)

(21) Appl. No.: 14/882,508

(22) Filed: Oct. 14, 2015

(30) Foreign Application Priority Data
Dec. 15, 2014 (KR) 10-2014-0180038

(51) Int. Cl. A61C 9/00

(52) U.S. Cl. CPC A61C 9/0006

(57) ABSTRACT

Provided is a metal bite strip used for producing an occlusal splint, the metal bite strip including: a first wax layer as a base layer; a first aluminum metal strip and a second aluminum metal strip formed to be spaced apart from each other on the first wax layer and formed by stacking a plurality of aluminum metal bite sheets; and a second wax layer and a third wax layer formed on the first aluminum metal strip and the second aluminum metal strip, respectively.

### BACKGROUND OF THE INVENTION

1. Field of the Invention

The present invention generally relates to an occlusal splint. More particularly, the present invention relates to a metal bite strip used for the production of an occlusal splint, which can protect a patient's teeth by relieving occlusal stress caused by teeth grinding or a deglutition movement (a motion to swallow saliva, food and the like in the mouth) and can relieve systemic diseases, such as a ringing in the ears, rhinitis, migraine, and the like by systemically generating a tractive force from a patient's atlas and axis vertebrae to act on central nerves and peripheral nerves, the occlusal splint being used in improving facial asymmetry and hormone balances via stabilization of a patient's sphenoid bone.

2. Description of the Related Art

An occlusal splint is a device with a thickness of 1.5 to 2 mm that can protect a patient's teeth by being inserted to cover a patient's posterior teeth when the patient sleeps or exercises, and can relieve systemic diseases, such as a ringing in the ears, rhinitis, migraine, and the like by systemically generating a tractive force from a patient's atlas and axis vertebrae to act on central nerves and peripheral nerves.

This occlusal splint is used in the following cases:

1) where teeth grinding is serious;

2) where abrasion to the teeth is serous due to occlusal instability, and an excessive force is applied to the teeth upon a deglutition movement performed one time per minute during sleep;

3) where periodontal diseases are serous;

4) where correction or prosthetic treatment is needed due to occlusal instability, but where circumstances do not allow such treatment;

5) where a general symptom is caused by twisting of the subluxation and temporomandibular joints of first and second cervical vertebrae;

6) where facial asymmetry is caused by a change in occlusion; and

7) where the pain of temporomandibular joints, lockjaw, mouth noises, and the like are generated.

Attempts to realize ideal occlusion contacts, namely, multiple simulation contacts for patients who cannot implement an ideal occlusion form (dots in a back line in the front) among patients who completed a general oral cavity treatment process, such as treatment of a decayed tooth, prosthetic treatment, gum treatment have been performed using a T-scan device.

When the posterior teeth perform a lateral movement, occlusion contacts are generated, and when occlusion distribution is stable, only a periodic occlusion test and treatment for periodontal diseases may be performed.

FIG. 1 schematically illustrates the importance of anterior guidance.

Anterior guidance is a mandibular movement adjusted by the roof of the mouth and a cutting surface upon an eccentric movement of the lower jaw. An anterior group function is derived from an idea that a force applied to an anterior teeth region upon a lateral movement can be more efficiently dispersed when several anterior teeth cause eccentric contacts. Thus, when the lower jaw performs a lateral movement, the canine teeth, lateral incisor teeth, and central incisor teeth cause eccentric contacts, thereby guiding the movement.

Since most patients do not have an ideal occlusion form, an occlusion force due to a lateral force 7˜8 times larger than that of the ideal occlusion form acts on the teeth, thereby acting on central nerves and peripheral nerves as subluxation of the first axis and the second axis caused by a left and right unbalance of jaw points due to distortion of the masticatory muscle. Thus, various systemic diseases of unknown cause may be generated.

In particular, distortion of the second axis has an influence on 136 muscles of the brain and spine.

Accordingly, when occlusion is unstable, an occlusal splint should be considered.

FIGS. 2A-C schematically illustrate an occlusal adjustment process using a T-scan III device.

The T-Scan III device (model name produced by Tekscan Company) is a device intended for measuring an occlusion force using a pressure sensor inserted into a patient's mouth, and may correctly measure an abnormal bite up to 0.01 mm. The T-Scan III device may be used in the case where tooth arrangement is abnormal, many cavities in the teeth are present, gum disease is present, jaw joints are abnormal, the mouth does not fully open, a sliding of the jaw occurs, and the like.

FIGS. 2A-C shows a measurement object on the left, a measurement result in the middle, and an appearance of the T-Scan III device on the right. The measurement result, illustrated in the middle view, is indicated as the distribution of pressure for each region.

The occlusal splint is produced by processes for taking a dental impression and bite and for fixing the appearance.

In the process for taking the dental impression, appearances of the upper and lower jaws are taken.

In the process of taking a bite impression, deglutition movements to swallow saliva are performed three˜four times in a state when the tongue comes into contact with the roof of the mouth. Then, an occlusion check wax (wax bite) is worn.

FIG. 3 illustrates a state in which a bite impression is taken using a conventional wax bite.

A position of centric occlusion can be checked by the bite illustrated in FIG. 3.

However, it is difficult to secure a space required for producing an occlusal splint, and to take correct bite because a position of the bite is changed according to a patient's force of holding the bite.

### SUMMARY OF THE INVENTION

Accordingly, the present invention has been made keeping in mind the above problems occurring in the related art, and an object of the present invention is to provide a metal bite strip that can facilitate the taking of bite.

Another object of the present invention is to provide a metal bite strip that enables ideal occlusion of the teeth in an ideal relation of joints using a correct centric relation (an indigenous basic relation of the patient's lower jaw when a patient's condyle is physiologically appropriately located in a patient's condylal fossa, and the lower jaw can easily perform a pure hinge movement).

A further object of the present invention is to provide a metal bite strip that can produce a patient-specific occlusal splint by providing a space with a size of 1.5 to 2 mm required for producing an optimum occlusal splint and serving as a stopper to maintain a correct temporomandibular joint relation.

In order to achieve the above object, according to one aspect of the present invention, there is provided a metal bite strip, including: a first wax layer as a base layer; a first aluminum metal strip and a second aluminum metal strip formed to be spaced apart from each other on the first wax layer and formed by stacking a plurality of aluminum metal bite sheets; and a second wax layer and a third wax layer formed on the first aluminum metal strip and the second aluminum metal strip, respectively.

Here, the first and second aluminum metal strips may be formed by stacking a plurality of perforated aluminum metal bite sheets and may have a total thickness of 1.5 to 2 mm.

Three perforated aluminum metal bite sheets with a thickness of 0.4 to 0.5 mm may be stacked.

A perforation size of the perforated aluminum metal bite sheets may be 0.7 mm.

Each of the first wax layer, and the second and third wax layers may have a thickness of 2 mm.

When the occlusal splint is produced using the metal bite strip according to the present invention, the jaws having a centric relation enable the teeth to have ideal occlusion at an ideal relation of jaws using a correct centric relation (an indigenous basic relation of the patient's lower jaw when a patient's condyle is physiologically appropriately located in a patient's condylal fossa, and the lower jaw can easily perform a pure hinge movement). That is, the posterior teeth are in uninform contact per one point, and the anterior teeth form dots in a back line in the front.

The metal bite strip according to the present invention may be produced in a thickness of 1.5 to 2 mm by stacking three 0.7 mm perforated aluminum metal bite sheets with a thickness of 0.4 to 0.5 mm and covering upper and lower parts thereof with wax, may provide a space having a size of 1.5 to 2 mm required for producing the optimum occlusal splint and may serve as a stopper for facilitating a correct temporomandibular joint relation so that a patient-specific occlusal splint can be produced.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 schematically illustrates importance of an anterior guidance.

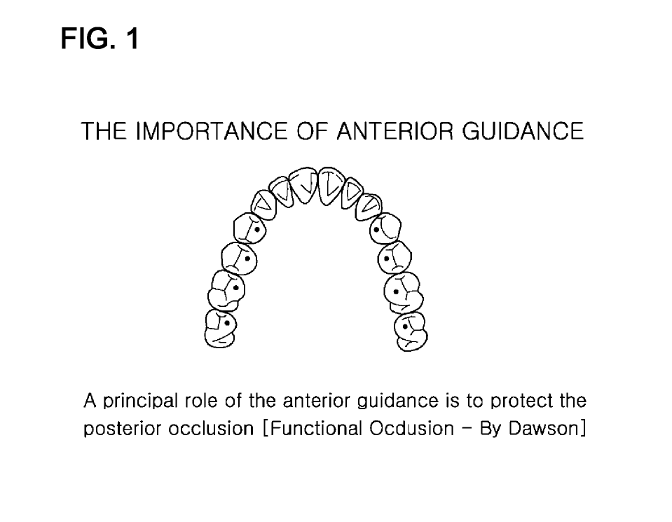

FIGS. 2A, 2B, and 2C schematically illustrate an occlusal adjustment process using a T-scan III device.

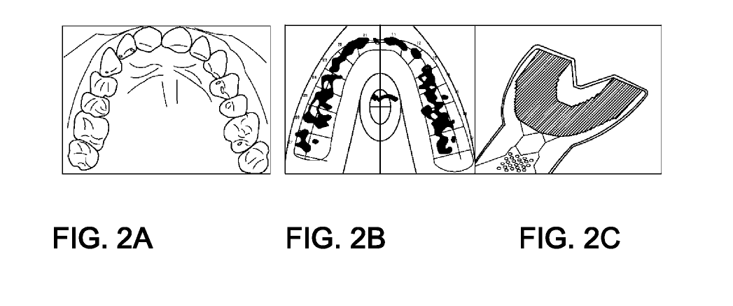

FIG. 3 schematically illustrates a state in which bite impression has been taken using a conventional wax bite.

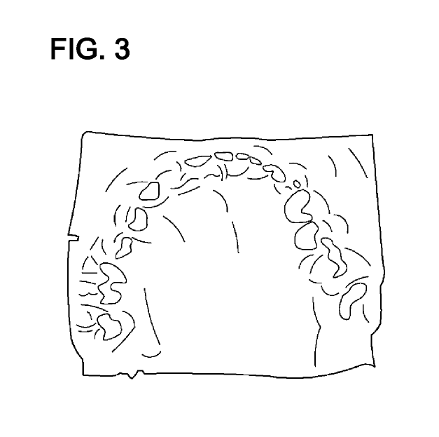

FIGS. 4A and 4B illustrate a perforated aluminum metal bite used in an aluminum metal bite of the present invention;

FIG. 5 is a plane view and a cross-sectional view showing the structure of a metal bite strip according to the present invention;

FIGS. 6A and 6B illustrate an appearance of a perforated aluminum metal bite according to the present invention;

FIG. 7 illustrates a state in which a bite impression has been taken using a metal bite strip according to the present invention; and

FIGS. 8A and 8B illustrate a process for producing a metal bite strip illustrated in FIGS. 5 to 6A-B, namely, an occlusal splint using the metal bite strip used to capture the impression of a bite.

### DETAILED DESCRIPTION OF THE INVENTION

Hereinbelow, the constitution and operation of the present invention will be described in detail with reference to the accompanying drawings.

A paraffin wax bite is the most commonly used method for determining occlusion in dental clinics. The paraffin wax bite enables a patent's upper jaw and lower jaw to naturally engage with each other so that centric occlusion can be confirmed. However, such a paraffin wax bite is seriously deformed, thereby causing frequent deformation and many errors during a process for mounting a model to a patient's occluder.

Meanwhile, an occlusal splint is generally formed at a thickness of 2 mm or more, and a thickness of 7 mm or more is harmful to a user's temporomandibular joint in the long term. For example, when a user performs a deglutition movement (a motion to swallow his or her saliva) for his or her upper and lower jaws and then takes a rest, a space called a freeway space is generated in the user's upper jaw and lower jaw. That is, when viewed from an anterior region, a space having a thickness of 2 to 4 mm is generated. When the occlusal splint has a larger thickness than the thickness, an excessive tensile force is applied to a user's muscles, and excessive tension is caused at the temporomandibular joint in the long term, thereby causing a harmful effect.

On the contrary, when the occlusal splint has a smaller thickness than 1.5 mm, a small amount of a tensile force for stretching the temporomandibular joint is generated. Thus, effects of the occlusal splint are reduced, and a risk of fracture of the occlusal splint occurs.

Accordingly, it is important to form the occlusal splint at a thickness ranging from about 1.5 to 2 mm. Since the paraffin wax bite causes many errors, it is difficult for a paraffin wax bite to satisfy such a requirement.

Also, when a bite is combined with a facial model, the facial model is fixed by putting the paraffin wax bite between the bite and the facial model and applying a force thereto. In accordance with the characteristics of paraffin wax, since the material is soft, even though the bite and the facial model are combined with each other in an incorrect direction, it is impossible to confirm the incorrect direction in terms of a dental technology. Also, due to this, when the occlusal splint is practically mounted to patients in dental clinics, many errors are generated.

Accordingly, even though a correct centric relation (an indigenous basic relation of the patient's lower jaw when a patient's condyle is physiologically appropriately located in a patient's condylal fossa, and the lower jaw can easily perform a pure hinge movement) is applied, it is difficult to secure an appropriate thickness (1.5 to 1.6 mm) of the occlusal splint clinically required during a process for producing the occlusal splint. Furthermore, when arbitrarily increasing a thickness of the bite in order to secure the appropriate thickness of the occlusal splint, a thickness of an occlusal surface of the posterior teeth causes a deviation ranging from 2 to 7 mm, and a very large error is generated from the right and left and top and bottom.

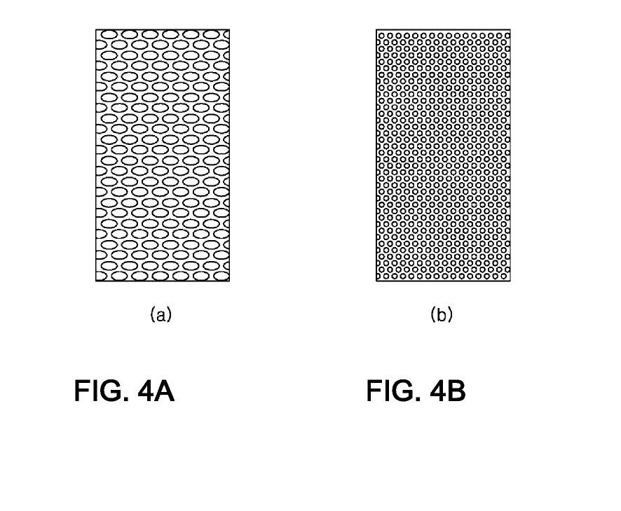

FIGS. 4A-B illustrate a perforated aluminum metal bite used in an aluminum metal bite of the present invention.

For evaluation of the metal bite strip according to the present invention, an experiment was carried out using a perforated aluminum metal bite with a thickness of 0.4˜5 mm and a perforation size of 0.7 mm and 1.5 mm. FIGS. 4A-B illustrate a 1.5 mm perferated aluminum metal bite and a 0.7 mm perforated aluminum metal bite.

Experiment 1

When a bite impression was taken by putting one 1.5 mm (perforation size) aluminum metal bite sheet in the middle and covering upper and lower parts thereof with wax, deformation was remarkably reduced compared to existing wax bite and aluwax bite. However, the bite was also insufficient to obtain an occlusal splint with a desired thickness of 1.5 to 2 mm.

Experiment 2

When a bite impression was taken by putting two 1.5 mm (perforation size) aluminum metal bite sheets in the middle and covering upper and lower parts thereof with wax, even though deformation was slightly reduced compared to the bite taken using one sheet, distortion was generated. This bite was also insufficient to obtain an occlusion splint with a desired thickness of 1.5 to 2 mm.

Experiment 3

When a bite impression was taken by putting three 1.5 mm (perforation size) aluminum metal bite sheets in the middle and covering upper and lower parts thereof with wax, even though the thickness of the aluminum metal bite was formed in a desired thickness, deformation in which the aluminum metal bite is dented was generated from patients having a large occlusion force because the perforation size was large. Accordingly, the bite was also insufficient to obtain an occlusal splint with a desired thickness of 1.5 to 2 mm.

Experiment 4

When a bite impression was taken by covering upper and lower parts of two 0.7 mm (perforation size) aluminum metal bite sheets with wax, deformation was generated from patients having a large occlusion force, and a thickness of the obtained occlusal splint also was only about 1 mm. The bite was also insufficient to obtain an occlusal splint with a desired thickness of 1.5 to 2 mm.

Experiment 5

When a bite impression was taken by covering upper and lower parts of three 0.7 mm (perforation size) aluminum metal bite sheets with wax, even in the case of patients having a large occlusion force, there was little deformation resulting from occlusion pressure. When the bite was correctly applied, it could be confirmed that an occlusal splint with an appropriate thickness was obtained.

The examples are summarized as shown in the following table.

TABLE 1

| | The Number | | |
|---|---|---|---|
| | of Aluminum | | |
| Perforation | Metal Bite | | |
| Size | Sheets | Result | Remark |
| 1.5 mm | One sheet | Deformation was | Inappropriate |
| | | remarkably reduced | |
| | | compared to bite and | |
| | | aluwax bite. | |
| 0.7 mm | Two sheets | Even though | Inappropriate |
| | | deformation was | |
| | | slightly reduced | |
| | | compared to the bite | |
| | | taken using one | |
| | | sheet, distortion was | |
| | | generated. | |
| | Three sheets | Even though the | Inappropriate |
| | | thickness of the | |
| | | aluminum metal bite | |
| | | was formed in a | |
| | | desired thickness, | |
| | | deformation in which | |
| | | the aluminum metal | |
| | | bite is dented was | |
| | | generated from | |
| | | patients having a | |
| | | large occlusion force | |
| | | because the | |
| | | perforation size was | |
| | | large | |
| | Two sheets | Deformation was | Inappropriate |
| | | generated from | |
| | | patients having a | |
| | | large occlusion | |
| | | force. | |
| | Three sheets | Even in the case of | Appropriate |
| | | patients having a | |
| | | large occlusion | |
| | | force, there was | |
| | | little deformation | |
| | | resulting from | |
| | | occlusion pressure. | |
| | | When the bite is | |
| | | correctly applied, an | |
| | | occlusal splint with | |
| | | an appropriate | |
| | | thickness was | |
| | | obtained. | |

Also, an experiment was carried out using a plane plate type 1.5 mm aluminum bite having no holes. However, a bite record was not properly performed because wax moved, a combination of the aluminum metal bite and the wax covering an outer surface of the aluminum metal bite was not appropriately performed, and the aluminum metal bite and the wax were separated from each other, thereby causing deformation of the bite. It was confirmed that the bite was inappropriate.

The reason why a posterior teeth part with a thickness of 1.5 to 2 mm is appropriate is because a freeway space is generated to the extent to thickness of the posterior teeth part of 1.5 to 2 mm. When a thickness of the occlusal splint is 4 to 5 mm, which is greater than 1.5 to 2 mm, an excessive amount of tensile force acts on the temporomandibular joint. Thus, it is inconvenient to use the occlusal splint and temporomandibular disorders may be caused.

Meanwhile, when the thickness of the occlusal splint is smaller than 1.5 to 2 mm, the occlusal splint is easily broken, and effects of the occlusal splint are reduced.

Accordingly, it is appropriate that the occlusal splint has the thickness of 1.5 to 2 mm. Also, when the bite is taken by stacking three 0.7 mm perforated aluminum metal bite sheets and covering upper and lower parts thereof with wax, the occlusal splint having an ideal centric relation may be produced because a position of the upper and lower jaws is naturally maintained in the most comfortable and ideal centric relation.

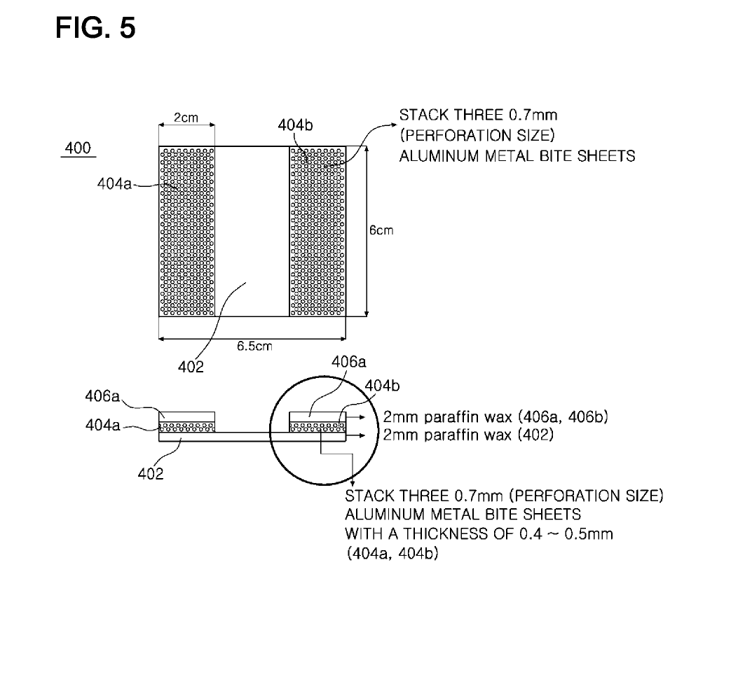

FIG. 5 is a plan view and a cross-sectional view showing the structure of a metal bite strip according to the present invention.

Referring to FIG. 5, a metal bite strip 400 according to the present invention includes: a first wax layer 402 as a base layer; a first aluminum metal strip 404a and a second aluminum metal strip 404b formed by stacking aluminum metal bite sheets on the first wax layer 402; a second wax layer 406a formed on the first aluminum metal strip 404a; and a third wax layer 406b formed on the second aluminum metal strip 404b.

The first and second aluminum metal strips 404a, 404b are spaced apart from each other by a predetermined distance. The first and second aluminum metal strips 404a, 404b are formed by stacking perforated aluminum metal bite sheets with a perforation size of 0.4 to 0.5 mm, and it is preferable that they have a total thickness of 1.5 to 2 mm.

The first and second aluminum metal strips 404a, 404b are formed by stacking three perforated aluminum metal bite sheets, and it is preferable that they have a perforation size of 0.7 mm. It is preferable that each of the first wax layer 402 and the second and third wax layers 406a, 406b have a thickness of 2 mm.

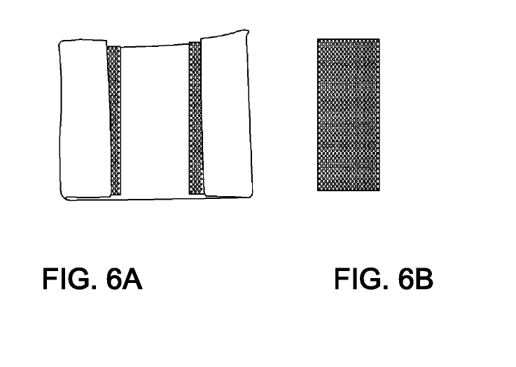

FIGS. 6A-B illustrate an appearance of the perforated aluminum metal bite sheet according to the present invention.

Each of the first and second aluminum metal strips 404a, 404b put into the metal bite strip 400 has a thickness of 1.5 to 2 mm, thereby providing a space with a size of 1.5 to 2 mm required for producing the occlusal splint and serving as a stopper for facilitating a correct temporomandibular joint relation.

The two aluminum metal strips 404a, 404b, which are spaced apart from each other, are intended to correspond to the teeth in both rows. The spaced potion between the two aluminum metal strips 404a, 404b is intended to correspond to the front teeth. That is, the occlusal splint illustrated in FIG. 5 is inserted into a gap between the upper jaw and the lower jaw and enables the upper and lower jaws to engage with each other, thereby measuring bite.

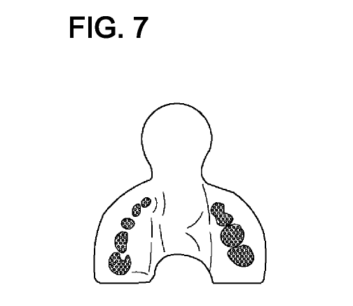

FIG. 7 illustrates a state in which bite is taken using the metal bite strip according to the present invention.

As illustrated in FIG. 7, when the bite is taken using the metal bite strip according to the present invention, the position of a centric relation can be checked, and a space required during a process for producing the occlusal splint can be easily secured. Furthermore, it can be seen that it is easy to treat patients, and a vertical dimension in the mouth can be exactly reproduced in an occluder.

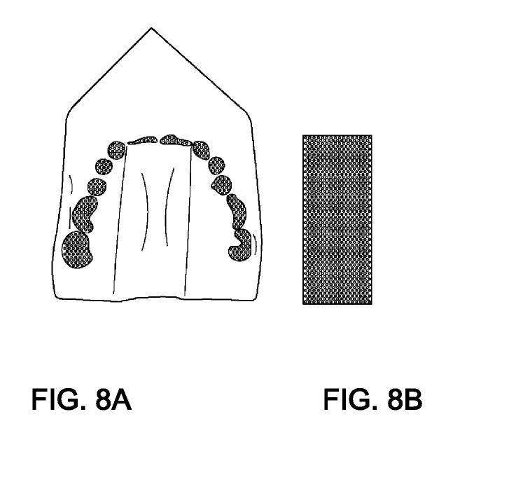

First, as illustrated in FIGS. 8A-B, the bite is taken using the metal bite strip.

When the occlusal splint is produced using the metal bite strip according to the present invention, the jaws having a centric relation enable the teeth to have ideal occlusion at an ideal relation. That is, the posterior teeth are in uninform contact per one point, and the anterior teeth form dots in a back line in the front.

The metal bite strip according to the present invention may be produced in the thickness of 1.5 to 2 mm by stacking three 0.7 mm perforated aluminum metal bite sheets with a thickness of 0.4 to 0.5 mm and covering upper and lower parts thereof with wax, may provide a space of 1.5 to 2 mm required for producing the optimum occlusal splint and may serve as a stopper for facilitating a correct temporomandibular joint relation so that a patient-specific occlusal splint can be produced.

The occlusal splint can reduce a change in occlusion, namely, the expression of periodontal diseases caused by the interference of occlusion, and the expression of occlusal diseases, such as tooth wear and cervical erosion caused by occlusion instability, and the like. Also, the occlusal splint can assist in the treatment of systemic diseases of unknown cause, such as migraine by asymmetry of left and right temporomandibular joints and subluxation of the first axis and the second axis, a ringing in the ears, rhinitis, hypertension, a disc and the like.

Also, the occlusal splint is effective to treat facial asymmetry and a hormone balance caused by torsion of 22 sphenoid bones located at the innermost portion of the cranium due to twisting of the lateral pterygoid and internal pterygoid caused by abrasion and the interference of occlusion.

Wearing of the occlusal splint, a correct posture of the spine, correct walking, correct abdominal respiration, a correct diet, and positive attitude are important for immunization of the human body from diseases.

Everyone produces about 400 to 10000 cancerous cells each day and overcomes the cancerous cells by immunity. The occlusal splint can restore the skull, which has a decisive influence on the spine and hormone serving as decisive factors to control autonomic nerves that are the most important for immunity, thereby functioning to activate the level of immunity.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A metal bite strip, which is a device for taking bite impressions required for producing an occlusal splint, the metal bite strip comprising:
a first wax layer as a base layer;
a first aluminum metal strip and a second aluminum metal strip formed to be spaced apart from each other on the first wax layer and formed by stacking a plurality of aluminum metal bite sheets; and
a second wax layer and a third wax layer formed on the first aluminum metal strip and the second aluminum metal strip, respectively.

2. The metal bite strip of claim 1, wherein the first and second aluminum metal strips are formed by stacking a plurality of perforated aluminum metal bite sheets and have a total thickness of 1.5 to 2 mm.

3. The metal bite strip of claim 2, wherein three perforated aluminum metal bite sheets with a thickness of 0.4 to 0.5 mm are stacked.

4. The metal bite strip of claim 2, wherein a perforation size of the perforated aluminum metal bite sheets is 0.7 mm.

5. The metal bite strip of claim 1, wherein each of the first wax layer, and the second and third wax layer has a thickness of 2 mm.
